(19) United States
(12) Patent Application Publication
(10) Pub. No.: US 2019/0268981 A1
(43) Pub. Date: Aug. 29, 2019

(54) COLOR-CHANGING OUTDOOR LIGHT WITH REDUCED-LEVEL WHITE MODE

(71) Applicant: J & J ELECTRONICS, LLC, Irvine, CA (US)

(72) Inventor: Alan V. DIEP, Foothill Ranch, CA (US)

(73) Assignee: J & J ELECTRONICS, LLC, Irvine, CA (US)

(21) Appl. No.: 16/285,498

(22) Filed: Feb. 26, 2019

Related U.S. Application Data
(60) Provisional application No. 62/635,762, filed on Feb. 27, 2018.

(51) Int. Cl. H05B 33/08

(52) U.S. Cl. CPC H05B 33/086; F21V 31/00; H05B 33/0845

(57) ABSTRACT

LED lights for use in an LED lighting system that includes an LED lighting control device that is electrically coupled to the LED lights. The LED lights include a white LED with a relatively higher lumen rating for safety and at least one non-white LED with a relatively lower lumen rating for aesthetics. The LED lights emit light in a number of different lighting schemes (e.g., light shows using different colors and/or patterns of emitted light) as directed by the LED lighting control device. For lighting schemes that include multiple colors with one color being white, the power level to the white LED is reduced, but not the power level to the other/non-white LEDS, so that the emitted white light is comparable in brightness to that of the non-white LEDs.

### CROSS-REFERENCE TO RELATED APPLICATION

This application claims the priority benefit of U.S. Provisional Patent Application Ser. No. 62/635,762 filed Feb. 27, 2018, the entirety of which is hereby incorporated herein by reference for all purposes.

### TECHNICAL FIELD

The present invention relates generally to the field of lighting, and more particularly to light-emitting diode (LED) multicolor lighting for outdoor areas such as swimming pools, spas, water features, pathways, and gardens.

### BACKGROUND

LED lighting is commonly used in swimming pools, spas, water features (e.g., decorative water fountains and water falls), gardens and landscaped areas, along pathways or walkways, and other outdoor areas where the LEDs are submerged in or exposed to water. In some installations, the LED lighting system includes LEDs for producing multiple colors (e.g., multiple different-colored LEDs or multicolor LEDs) and a control device that is programmed to cause the LEDs to emit light in a number of different lighting schemes (e.g., light shows using different colors and/or patterns of emitted light). For example, one lighting scheme can cause the LED lights to all display a single color (e.g., solid green) continuously. Other lighting schemes can include causing the LED lights to display light shows in which a plurality of different colors are displayed in particular sequences and/or durations.

For such lighting-scheme applications, the LED lights are commonly provided with red, green, and blue LEDs, referred to as “RGB” LED lights. These LEDs can be powered individually to display solid red, green, and blue light, respectively, or in combination to display other colors. Oftentimes it is desired to operate the LED lights to display white light. For this, all three LEDs can be powered together, with the three colors combining to display a white light. However, the resulting white light has a pinkish hue and is therefore not ideal.

To address this, LED lights have been provided in an “RGB+white” or “RGBW” format that additionally includes a dedicated white-light LED. This advantageously results in a mode for producing pure white light without drawbacks associated with blending colors. However, for lighting schemes using multiple colors including white, with all supplied the same power, the white light produced by the LED lights is much brighter than the other colors and tends to overwhelm them, resulting in a somewhat unbalanced and less visually pleasing light display.

Accordingly, it can be seen that needs exist for improvements in LED multicolor lighting for outdoor areas. It is to the provision of solutions to this and other needs that the present invention is primarily directed.

### SUMMARY

Generally described, the present invention relates to LED lights for use in an LED lighting system that includes an LED lighting control device that is electrically coupled to the LED lights. The LED lights emit light in a number of different lighting schemes (e.g., light shows using different colors and/or patterns of emitted light) as controlled by the LED lighting control device. For a static white lighting scheme, the white light is brighter for safety purposes. But for lighting schemes that include multiple colors with one color being white, the power level to the white LED is reduced, but not the power level to the other LEDS, so that the emitted white light is comparable in brightness to that of the non-white LEDs for aesthetic purposes. The LED lights can be used in swimming pools, spas, water features, gardens and landscaped areas, along pathways or walkways, and other outdoor areas where the LEDs are submerged in or exposed to water, or they can be used in any other lighting application as may be desired. Example representative embodiments of such LED lights and LED lighting systems are described below with reference to the figures.

The specific techniques and structures employed to improve over the drawbacks of the prior devices and accomplish the advantages described herein will become apparent from the following detailed description of example embodiments and the appended drawings and claims.

### BRIEF DESCRIPTION OF THE DRAWINGS

FIG. 1 is a block diagram of an LED lighting system including LED lights according to an example embodiment.

FIG. 2 is a schematic diagram of one of the LED lights of FIG. 1.

FIG. 3 is a circuit diagram of a printed circuit board of the LED light of FIG. 2.

FIG. 4 is a flow diagram of a control method performed by the onboard control device of the LED light of FIG. 2.

### DETAILED DESCRIPTION OF EXAMPLE EMBODIMENTS

The invention may be understood more readily by reference to the following detailed description of example embodiments taken in connection with the accompanying drawing figures, which form a part of this disclosure. It is to be understood that this invention is not limited to the specific devices, methods, conditions, or parameters described and/or shown herein. Any and all patents and other publications identified in this specification are incorporated by reference as though fully set forth herein.

The terminology used herein is for purposes of describing particular embodiments only, and is not intended to be limiting. The defined terms are in addition to the technical, scientific, or ordinary meanings of the defined terms as commonly understood and accepted in the relevant context.

The words “example” and “exemplary,” as used herein, are intended to be non-exclusionary and non-limiting in nature. More particularly, these words indicate one among several examples, with no undue emphasis or preference being directed to the particular example being described.

The singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

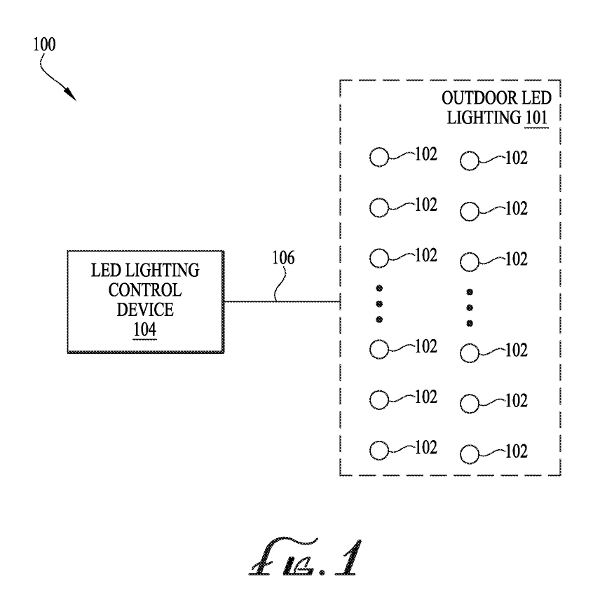

With reference now to the drawing figures, wherein like reference numbers represent corresponding parts throughout the several views, FIG. 1 shows a block diagram of an LED lighting system 100 according to an example embodiment. The LED lighting system 100 includes outdoor LED lighting 101 and an LED lighting control device 104 that controls the LED lighting 101 for displaying a number of different lighting schemes. The LED lighting 101 is electrically hard-wired 106 to the LED lighting control device 104, which typically is housed in a panel or outlet box installed nearby (e.g., in the pool/spa area), so that the electric power to the LED lighting 101 is controlled via the LED lighting control device 104.

The LED lighting control device 104 typically has a user interface, for example a dial or selector on its face, to allow a user to manually select a desired lighting scheme from the variety of pre-programmed lighting schemes. In some embodiments, the LED lighting control device 104 additionally or alternatively provides for remote control for example by a BLUETOOTH-enabled device such as a smartphone. An example of such an LED lighting control device 104 is disclosed by U.S. Patent Application Publication No. 2018/0116041, published Apr. 26, 2018, and titled “LIGHTING SYSTEM CONTROLLER CONFIGURED TO BE REMOTELY CONTROLLED VIA A BLUETOOTH-ENABLED WIRELESS DEVICE FOR CONTROLLING OUTDOOR LED LIGHTING,” which is hereby incorporated by reference herein.

To control the lighting schemes, the LED lighting control device 104 communicates one or more lighting-scheme identifiers to the LED lighting 101 to begin displaying one or more respective lighting schemes. In the depicted embodiment, for example, the lighting-scheme identifiers are each a unique number of times the power is toggled (i.e., sequenced) on and off rapidly. In such embodiments, the LED lighting control device 104 turns the power on and off rapidly a particular number of times, with this lighting-scheme identifier corresponding to a particular lighting scheme, and the LED lights each include an onboard control device (described below) that interprets these on/off power toggles and causes the LED lights to display the user-selected lighting scheme.

Some examples of this are now provided for illustration purposes. In one example, to cause the outdoor LED lighting 101 to display a lighting scheme corresponding to a static green color, the LED lighting control device 104 may turn the power on and off rapidly five times (the “solid green” lighting-scheme identifier). To cause the outdoor LED lighting 101 to display a lighting scheme corresponding to a static white color, the LED lighting control device 104 may turn the power on and off rapidly seven times (the “solid white” lighting-scheme identifier). To cause the outdoor LED lighting 101 to display a dynamic lighting scheme corresponding to a particular light show made up of a plurality of different colors such as blue and green displayed in a particular sequence and for particular time periods, the LED lighting control device 104 may turn the power on and off rapidly nine times (the “tidal wave” lighting-scheme identifier). And to cause the outdoor LED lighting 101 to display a dynamic lighting scheme corresponding to a particular light show made up of a plurality of different colors such as red, white, and blue displayed in a particular sequence and for particular time periods, the LED lighting control device 104 may turn the power on and off rapidly eleven times (the “patriot dream” lighting-scheme identifier). More or fewer static lighting schemes (constant single colors) and/or dynamic lighting schemes (e.g., different colors, sequences, and/or time periods) can be implemented by other lighting-scheme identifiers (e.g., different unique numbers of power on/off toggles), as will be understood by persons of ordinary skill in the art. As noted above, these examples are representative for explanatory purposes only, and thus they are in no way limiting of the invention.

In other embodiments, the lighting-scheme identifiers are provided by other types of communications from the LED lighting control device 104 to the LED lighting 101. For example, in some contemplated embodiments the LED lighting control device 104 is hard-wired with low-voltage control wiring to the LED lighting 101 and the lighting-scheme identifiers are provided by other conventional control signals. And in other embodiments, the LED lighting control device 104 includes a transmitter and the LED lighting 101 includes a receiver with these components adapted for wireless communications to send lighting-scheme identifiers that are conventional wireless control signals. In such embodiments, because the lighting-scheme identifiers can be conventional control signals, they can identify the user-selected lighting scheme without any interpretation, so the onboard control device (described below) can still control the LED lights 101 to display the user-selected lighting scheme but does not need to interpret the lighting-scheme identifiers to do so. And in some such embodiments, the LED lighting control device 104 directly and centrally/remotely controls all of the LED lights 101, and the local-control components (e.g., the processing logic and lighting schemes program as described below) can be eliminated from each of the onboard control devices and a single set of these control components can be provided in the LED lighting control device 104.

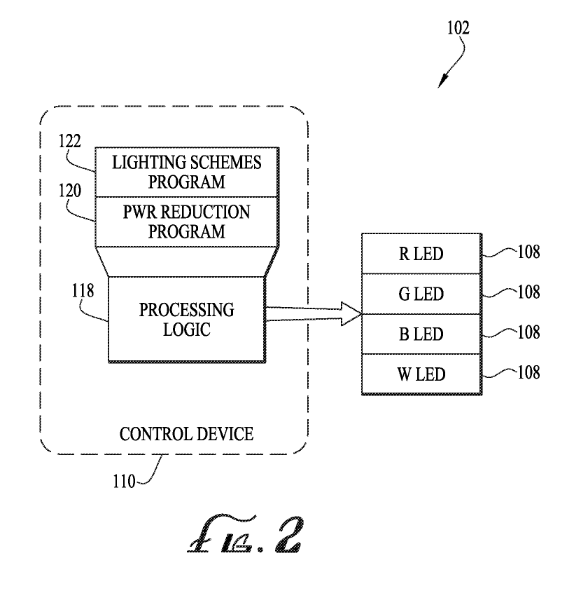

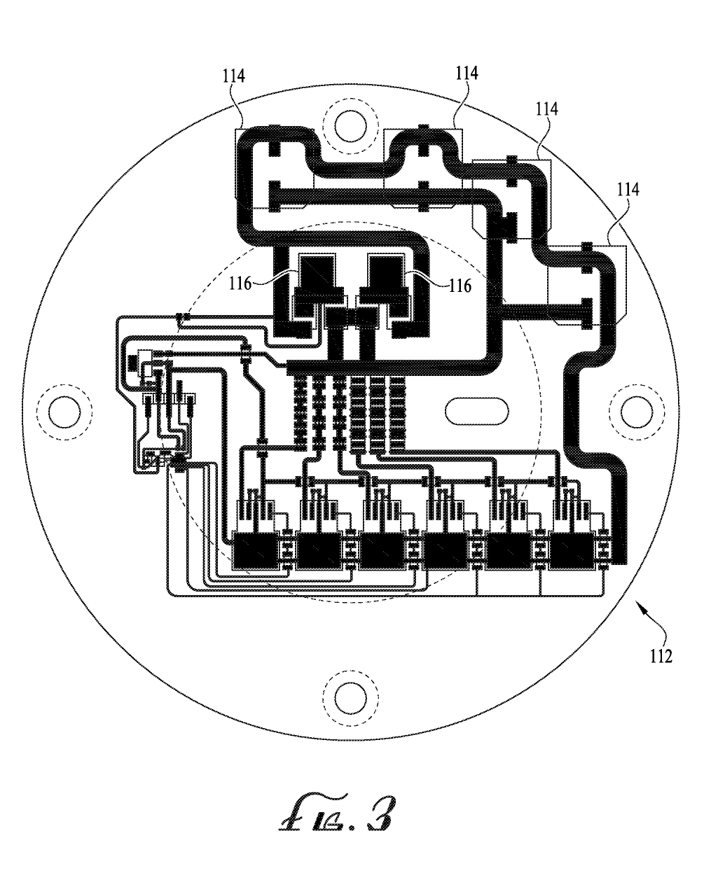

Referring additionally to FIGS. 2-3, the outdoor LED lighting 101 is an arrangement of one or more (typically, several) LED lights 102 that can be arranged in an array for example around the periphery of a pool, recessed into the pool wall, and below the waterline. Each of the LED lights 102 includes a plurality of monochromatic LEDs 108 of different colors. For example, the LED lights 102 can each have an “RGBW” format with four monochromatic LEDs 108 that each emit one color of red, green, blue, and white light. In some embodiments, each LED 108 can be provided by a plurality of LEDs of the same color wired and controlled together. In other embodiments, each LED light 102 includes only one LED 108 with multiple different-colored LEDs in the array and/or with the one LED being a multicolor LED. And in still other embodiments, the LED 108 are provided in other colors, for example additionally or alternatively including yellow, orange, and/or violet. The LEDs 108 for typical pool and spa applications are rated 12 VDC, though LEDs rated at other DC voltages can be used as may be desired in a particular application. Other types and arrangements of LEDs are within the knowledge of persons of ordinary skill in the art and are thus within the scope of the invention.

In order to meet pool-lighting safety requirements (e.g., as directed by municipalities and other authorities), the white LEDs 108 of the LED lights 102 are typically selected with an illumination rating of about 3000 lumens to about 5000 lumens, most commonly 4000 lumens. So in a static-white lighting scheme, the LED lighting 101 continuously blankets the pool with constant bright white light for safety purposes. The red, green, and blue LEDs 108 are typically used only for the decorative lighting schemes, so they do not need to provide such bright lighting, and so typically they each have a lower lumen rating than the white LEDs 108. In particular, the red, green, and blue LEDs 108 typically each have a lumen rating of about 100 lumens to about 1,400 lumens, most commonly 1000 lumens. The electrical power connection 106, and thus the power delivered, is the same for all of the LEDs 108 in the LED lights 102 (i.e., each LED light 102 is connected to the LED lighting control system 110 by a single respective power line). For example, a single/common electrical wire typically delivers 120 VAC power to all of the LEDs 108 in the LED lights 102, so each LED is driven by the same power level.

The LED lights 102 each include an onboard control device 110 that is electrically connected to and individually controls the LEDs 108 of that LED light 102, and that is electrically connected to and controlled by the LED lighting control device 104. The onboard control device 110 includes an LED driver that regulates the power to the LEDs 108, for example by converting AC to DC (e.g., 120 VAC to 12 VDC) and maintaining a constant power level. The LED driver can be designed into a circuit board 112 of the LED light 102, as is well within the ordinary skill in the art, and as in the depicted embodiment. Or the LED driver can be provided as a discrete component (e.g., of a conventional type as is commercially available from many sources) that is integrated into the control device 110. An example LED driver is disclosed by U.S. Pat. No. 8,123,381 issued Feb. 28, 2012, and titled “LED LIGHTING SYSTEMS AND METHODS USEABLE FOR REPLACEMENT OF UNDERWATER NICHE LIGHTS AND OTHER APPLICATIONS,” which is hereby incorporated by reference herein. The circuit board 112 also includes LED connections 114 (for mounting and electrically connecting the LEDs 108), power connections 116 (for electrically connecting the power wiring 106), and the like for mounting and integrating the various device components together for operation. It will be understood that although each control device 110 of this embodiment is “onboard” and thus local and integral to its respective LED light 102, in other embodiments this control device can be remote and in communication with the LEDs 108. It will also be understood that in DC-powered systems, for example powered by a solar panel array, the LED driver is not needed and can be eliminated.

In addition, the onboard control device 110 includes processing logic 118 that executes firmware or software of a lighting schemes program 122 that interprets the lighting-scheme identifiers (e.g., the on/off power toggles) received form the LED lighting control device 104 and causes the outdoor LED lighting 101 to display the user-selected lighting scheme. The processing logic 118 may be implemented solely in hardware or in a combination of hardware and software and/or firmware. For illustrative purposes, the processing logic 118 is implemented as a microcontroller or a microprocessor that executes software and/or firmware of a lighting schemes program 122. The lighting schemes program 122 thus includes computer instructions for implementing the various lighting schemes, for example static single-color displays and the dynamic multicolor light shows such as those described above.

Furthermore, the processing logic 118 executes firmware or software of a power-reduction program 120 that includes computer instructions that operate to selectively reduce (e.g., to a predetermined level or by a predetermined amount) the power to the white LED 108 when a multi-color light show has been identified as the user's selection. The power-reduction program 120 may be implemented as firmware and/or software, or it can even be designed into a circuit included on the circuit board. Additional details of the power-reduction program 120 are described below.

As indicated, the processing logic 118 is typically provided by a device that is programmable with software and/or firmware, such as a microprocessor or a microcontroller, but alternatively may comprise other types of logic such as, for example, a programmable gate array (PGA), a programmable logic array (PLA), an application specific integrated circuit (ASIC), etc. The processing logic 118 may be integrated with a memory device (not shown) into a single device, such as an integrated circuit (IC) chip, or they may be separate devices, such as separate IC chips that are interconnected via a bus. The memory device is typically a non-transitory computer-readable memory storage medium, for example a solid-state memory device such as a random access memory (RAM) chip, a read only memory (ROM) chip, a flash memory chip, etc., but could be some other type of memory device, such as an optical or magnetic memory device, for example. In firmware embodiments, the lighting schemes program 122 and/or the power-reduction program 120 are stored in non-transitory non-volatile memory storage devices such as ROM, EPROM, or flash memory. And the processing logic 118 may execute computer instructions comprising an operating system (not shown) that controls additional operations of the onboard control device 110, including operations performed by the LED light 102 when the processing logic 118 is executing the lighting schemes program 122 and/or the power-reduction program 120.

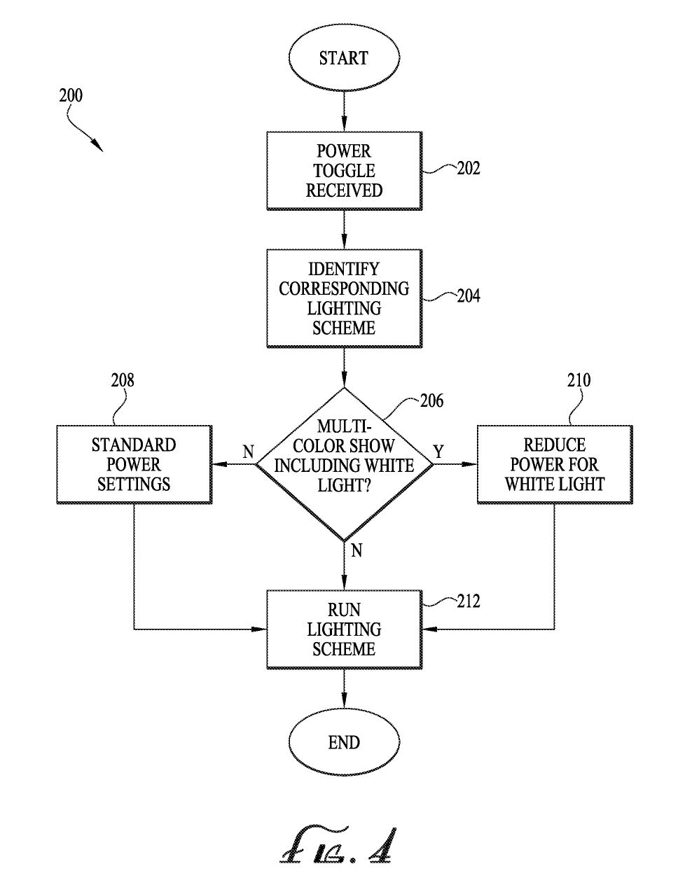

FIG. 4 shows a control method 200 for the LED lights 102 that describes and implements the lighting schemes program 122 and the power-reduction program 120. At 202, a lighting-scheme identifier is received from the LED lighting control device 104. In the depicted embodiment, this is implemented by a particular number of toggles (of the power being rapidly turned on and off by the LED lighting control device 104) being detected. Then, at 204, a particular one of the lighting schemes is identified as corresponding to the received lighting-scheme identifier (e.g., particular number of power toggles). Using the example lighting schemes from above, five toggles is interpreted as a selection of the static green lighting scheme, seven toggles is interpreted as a selection of the static white lighting scheme, nine toggles is interpreted as a selection of the dynamic blue and green lighting scheme, and eleven toggles is interpreted as a selection of the dynamic red, white, and blue lighting scheme. These process steps can be part of the lighting schemes program 122 and/or implemented by firmware and/or software.

As part of the power-reduction program 120, at 206, a determination is made whether the particular lighting scheme selected is a multicolor dynamic lighting scheme that includes the white LED 108 in the light show. This can be done by the lighting-scheme identifiers for all multicolor dynamic lighting schemes that include the white LEDs 108 being recognized as requiring a reduced power level for the white LED 108, by all other lighting-scheme identifiers being recognized as not requiring a reduced power level, or by other techniques.

If at 206 the particular lighting scheme selected is not a multicolor dynamic lighting scheme that includes the white LED 108 in the light show, then at 208 a standard power level setting is used. Continuing with the above examples of lighting schemes, for a selection of the five-toggle static green lighting scheme, the seven-toggle static white lighting scheme, or the nine-toggle dynamic blue and green lighting scheme, the power to the LEDs 108 is not adjusted from the standard setting. So the standard power setting is used for all four of the RGBW LEDs 108.

But if at 206 the particular lighting scheme selected is a multicolor dynamic lighting scheme that includes the white LED 108 in the light show, then at 210 the power level for the white LED 108 is adjusted relative to the power level to the other LEDs 108 used in the particular lighting scheme. In the depicted embodiment, the power level for the white LED 108 is reduced, without adjusting the standard power level to the other LEDs 108 used in the particular lighting scheme. Continuing with the above examples of lighting schemes, for a selection of the eleven-toggle dynamic red, white, and blue lighting scheme, the reduced power setting is used for the white LED 108 and the standard power setting is used for the red and blue LEDs 108.

It will be understood that the determination at 206 of whether the selected lighting scheme is a multicolor dynamic lighting scheme including white, as disclosed herein, includes a determination of simply whether the selected lighting scheme is a multicolor dynamic lighting scheme (with or without white), such that the standard power setting is used for all static lighting schemes and the reduced-power setting for white is used for all dynamic lighting schemes (if there is no white in the light show, the reduced power to it has no visible effect).

Finally, at 212 the particular lighting scheme selected is implemented by the LEDs 108, based on the standard and/or reduced power levels as set at 208 or 210. The resulting static white light display provides the desired safety performance, and the resulting dynamic sequenced-light shows provide the desired smooth transitions between colors including white.

In typical embodiments, the method provides that if the particular lighting scheme selected is a static light display of any color (white or another color), then the standard power setting is used. For white, the higher power is desired for safety. But regardless of the color selected, there is no sequential changing between white and another color, so it is acceptable for the red, green, or blue static display to use the standard (higher) power setting. In other embodiments, the reduced-power setting can be used for a static light display of any non-white color.

In addition, if the particular lighting scheme selected is a dynamic multicolor light show of any different colors (including or excluding white), then the reduced power setting is used for the white LED 108. For dynamic multicolor light shows including white and other colors, the lower white-light LED power is desired for providing comparable brightness across the sequence of different emitted lights. But if the dynamic multicolor light show does not include white, then there is no sequential changing between white and another-color LED, so it is acceptable for the red, green, or blue dynamic display to use the standard (higher) power setting. In other embodiments, the reduced-power setting can be used for a dynamic multicolor light display of only non-white colors.

The power level reduction amount is based on a desired lumen output of the white LED 108 to be comparable in brightness to the lumen output of the non-white (e.g., red, blue, and/or green) LEDs 108 used in the particular lighting scheme selected. For example, the power reduction can be a percentage, such as to an about 25-percent reduced-power level (e.g., an about 75-percent power reduction), to thereby reduce the brightness of the white LED 108 from about 4000 lumens to about 1000 lumens, to be substantially the same (i.e., visually comparable to the naked human eye) as the 1000 lumen output of the red and blue LEDs 108. In typical embodiments, the power to the white LED 108 is reduced to the reduced-power level using pulse-width modulation (PWM), which is a well-known control in the art of controlling LEDs. For example, PWM can be implemented to reduce 300 steps for standard (e.g., full) power to 75 steps for reduced power to the white LED 108 when in the multicolor show mode, thereby reducing the current/voltage to the white LED 108 by 75 percent (e.g., from 100-percent duty cycle to 25-percent duty cycle) and thereby causing it to emit 75-percent less light so that its brightness is generally comparable to that of the other LEDs 108. The implementation of PWM in the power-reduction program is well within the ordinary skill level in the art, and so further details are not provided for brevity. For example, in the depicted embodiment with the LED driver designed into the control circuit, the PWM can be implemented in firmware. In other embodiments, the PWM is included in a discrete LED driver component. In any event, the electrical power delivered by the common/main power fed 106 is distributed to each of the individual LEDs 108 (e.g., to the LED drivers) with the individual power feed to the white LED 108 being controlled by the power-reduction program to selectively reduce the power level to it.

In another embodiment, the power-reduction program includes a low or reduced power circuit for dynamic multicolor white-included lighting schemes and a high or increased power circuit for all other lighting schemes (all static single-color lighting schemes and dynamic multicolor white-excluded lighting schemes). In yet another embodiment, a DC-to-DC converter is provided and adapted for implementing the power-reduction program. And in another embodiment, instead of reducing the white LED power level for multicolor lighting schemes, the control device for the LED light can be configured to increase the power to the non-white LEDs for such lighting schemes, from a reduced-power level to all the LEDs in a standard power mode, with the non-white LEDs selected to operate at the increased power level.

While the invention has been described with reference to example embodiments, it will be understood by those skilled in the art that a variety of modifications, additions, and deletions are within the scope of the invention, as defined by the following claims.

What is claimed is:

1. An LED light, comprising:
a plurality of LEDs of different colors including at least one white-light LED and at least one non-white LED;
a lighting scheme program with computer instructions for operating the LED lights to emit light according to multiple lighting schemes, wherein at least one of the lighting schemes displays static white light only and at least one of the lighting schemes displays a sequence of different lights including white light and non-white light;
a power-reduction program with computer instructions for reducing, by or to a preset amount, a power level to the white LED when a selection is received for the lighting scheme that displays a sequence of different lights including white light and non-white light, without reducing a power level to the non-white LED, wherein the white light emitted by the white LED is at a greater brightness for the lighting scheme that displays static white light only than for the lighting scheme that displays a sequence of different lights including white light and non-white light, and wherein, for the lighting scheme that displays a sequence of different lights including white light and non-white light, the brightness of the white light emitted by the white LED is substantially the same as a brightness of the non-white light emitted by the non-white LED; and
processing logic for implementing the computer instructions of the lighting scheme program and the power-reduction program to display each of the lighting schemes.

2. The LED light of claim 1, wherein the at least one white-light LED is provided by a red LED, a green LED, and a blue LED.

3. The LED light of claim 1, wherein the white-light LED has a lumen rating that is about four times greater than a lumen rating of the non-white-light LED.

4. The LED light of claim 3, wherein the white-light LED lumen rating is about 4000 and the none-white-light LED lumen rating is about 1000.

5. The LED light of claim 1, further comprising an onboard control device that includes the lighting scheme program, the power-reduction program, and the processing logic.

6. The LED light of claim 5, wherein the lighting scheme program and the power-reduction program are implemented in firmware of the onboard control device.

7. The LED light of claim 5, wherein the onboard control device further includes LED drivers to regulate power to the LEDs.

8. The LED light of claim 1, wherein the power-reduction program implements pulse-width modulation to reduce the power duty cycle to the white LED, but not to the non-white LED, for the lighting scheme that displays a sequence of different lights including white light and non-white light.

8. The LED light of claim 1, wherein the power-reduction program implements pulse-width modulation to reduce the power level to the white LED, but not to the non-white LED, for the lighting scheme that displays a sequence of different lights including white light and non-white light.

9. The LED light of claim 8, wherein the pulse-width modulation reduces a power duty cycle to the white LED, but not to the non-white LED.

10. The LED light of claim 1, wherein the lighting scheme program identifies selections of the lighting schemes based on respective lighting-scheme identifiers received from a remotely located LED lighting control device.

11. The LED light of claim 10, wherein the lighting-scheme identifiers are unique numbers of times power to the LED light is toggled on and off, wherein each unique number corresponds to a respective one of the lighting schemes.

12. The LED light of claim 1, wherein the LED light is adapted for use when submerged in or exposed to water.

13. An LED lighting system, comprising:
a plurality of LED lights each including a plurality of LEDs of different colors including at least one white-light LED and at least one non-white LED;
an LED lighting control device that is electrically connected to the LED lights;
a lighting scheme program with computer instructions for operating the LED lights to emit light according to multiple lighting schemes, wherein at least one of the lighting schemes displays static white light only and at least one of the lighting schemes displays a sequence of different lights including white light and non-white light;
a power-adjustment program with computer instructions for adjusting, by or to a preset amount, a power level to at least one of the LEDs when a selection is received for the lighting scheme that displays a sequence of different lights including white light and non-white light, wherein the white light emitted by the white LED is at a greater brightness for the lighting scheme that displays static white light only than for the lighting scheme that displays a sequence of different lights including white light and non-white light, and wherein, for the lighting scheme that displays a sequence of different lights including white light and non-white light, the brightness of the white light emitted by the white LED is substantially the same as a brightness of the non-white light emitted by the non-white LED; and
processing logic for implementing the computer instructions of the lighting scheme program and the power-reduction program to display each of the lighting schemes.

14. The LED lighting system of claim 13, wherein each one of the LED lights is connected to the LED lighting control device by a single respective power line.

15. The LED lighting system of claim 13, wherein the LED lights each include an onboard control device that includes the lighting scheme program, the power-reduction program, and the processing logic.

16. The LED lighting system of claim 13, wherein the power-reduction program implements pulse-width modulation to reduce the power duty cycle to the white LED, but not to the non-white LED, for the lighting scheme that displays a sequence of different lights including white light and non-white light.

17. The LED lighting system of claim 13, wherein the lighting scheme program identifies selections of the lighting schemes based on respective lighting-scheme identifiers received from the LED lighting control device.

18. The LED lighting system of claim 17, wherein the lighting-scheme identifiers are unique numbers of times power to the LED light is toggled on and off, wherein each unique number corresponds to a respective one of the lighting schemes.

19. A method of controlling LED lights electrically connected to an LED lighting control device in an LED lighting system, the LED lights each including white LEDs and non-white LEDs, the method comprising:
receiving a lighting-scheme indicator from the LED lighting control device;
identifying a lighting scheme corresponding to the received lighting-scheme indicator;
determining if the identified lighting scheme displays a sequence of different lights including white light and non-white light;
if so, then reducing power to the white LED without reducing power to the non-white LED; and
if not, then not reducing power to the white LED or the non-white LED,
wherein for lighting scheme that displays a sequence of different lights including white light and non-white light, a brightness of the white light emitted by the white LED is substantially the same as a brightness of the non-white light emitted by the non-white LED, and wherein the white light emitted by the white LED is at a greater brightness for a lighting scheme that displays static white light only than for the lighting scheme that displays a sequence of different lights including white light and non-white light.

20. A non-transitory memory device storing instruction sets for computer-implementation of the method of claim 19.
